(19) United States
(12) Patent Application Publication
(10) Pub. No.: US 2012/0076556 A1
(43) Pub. Date: Mar. 29, 2012

(54) FIXING DEVICE AND IMAGE FORMING APPARATUS

(75) Inventor: Hitoshi KOMURO, Kanagawa (JP)

(73) Assignee: FUJI XEROX CO., LTD., Tokyo (JP)

(21) Appl. No.: 13/041,774

(22) Filed: Mar. 7, 2011

(30) Foreign Application Priority Data
Sep. 24, 2010 (JP) 2010-213967

(51) Int. Cl. G03G 15/20

(52) U.S. Cl. 399/329

(57) ABSTRACT

A fixing device includes a circularly moving member, the outer peripheral surface of which circularly moves; a belt-shaped member that has a substantially belt shape and that circularly moves while an outer peripheral surface of the belt-shaped member is in contact with the outer peripheral surface of the circularly moving member; a pressing member that presses the belt-shaped member onto the circularly moving member while being in contact with an inner peripheral surface of the belt-shaped member; and a lubricant dispersion member that includes a solid material and a lubricant dispersed in the solid material in the form of particles, wherein the lubricant dispersion member is worn by being rubbed on the inner peripheral surface of the belt-shaped member, and the lubricant is exposed on a surface of the solid material by wear, the surface contacting the inner peripheral surface of the belt-shaped member.

### CROSS-REFERENCE TO RELATED APPLICATIONS

This application is based on and claims priority under 35 USC 119 from Japanese Patent Application No. 2010-213967 filed Sep. 24, 2010.

### BACKGROUND

The present invention relates to a fixing device and an image forming apparatus.

### SUMMARY

According to an aspect of the invention, there is provided a fixing device including a circularly moving member, the outer peripheral surface of which circularly moves; a belt-shaped member that has a substantially belt shape and that circularly moves while an outer peripheral surface of the belt-shaped member is in contact with the outer peripheral surface of the circularly moving member; a pressing member that presses the belt-shaped member onto the circularly moving member while being in contact with an inner peripheral surface of the belt-shaped member; and a lubricant dispersion member that includes a solid material and a lubricant dispersed in the solid material in the form of particles, in which the lubricant dispersion member is worn by being rubbed on the inner peripheral surface of the belt-shaped member, and the lubricant is exposed on a surface of the solid material by wear, the surface contacting the inner peripheral surface of the belt-shaped member.

### BRIEF DESCRIPTION OF THE DRAWINGS

Exemplary embodiments of the present invention will be described in detail based on the following figures, wherein:

FIG. 1 is a schematic view showing an image forming apparatus according to an exemplary embodiment of the present invention;

FIG. 2 is a cross-sectional side view showing the structure of a fixing device of the image forming apparatus shown in FIG. 1;

FIG. 3 is a view of a part of the fixing device shown in FIG. 2, viewed from a direction in which a sheet is transported;

FIG. 4 is a partial cross-sectional view showing the structure of a low-friction sheet; and

FIG. 5 is a partial cross-sectional view showing the structure of a low-friction sheet according to a second exemplary embodiment.

### DETAILED DESCRIPTION

Exemplary embodiments of the present invention will now be described with reference to the accompanying drawings.

### First Exemplary Embodiment

### Image Forming Apparatus

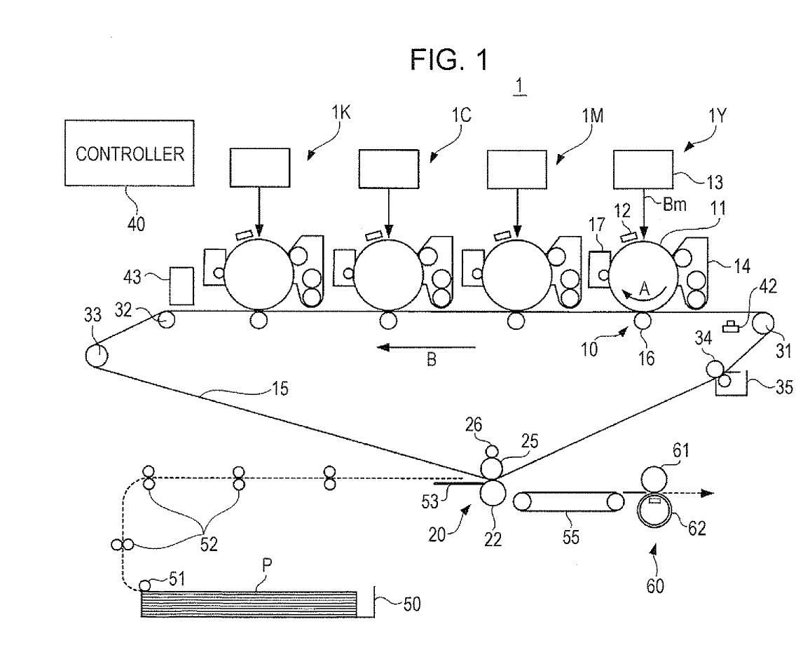

FIG. 1 is a schematic view showing an image forming apparatus according to an exemplary embodiment of the present invention.

An image forming apparatus 1 shown in FIG. 1 is an intermediate transfer-type printer. The image forming apparatus 1 includes multiple image forming units 1Y, 1M, 1C, and 1K configured to form toner images of respective color components by an electrophotographic system, first transfer units 10 configured to sequentially transfer (primarily transfer) the toner images of the respective color components formed by the image forming units 1Y, 1M, 1C, and 1K onto an intermediate transfer belt 15, a second transfer unit 20 configured to transfer (secondarily transfer) superimposed toner images transferred on the intermediate transfer belt 15 onto a sheet P which is a recording material (recording paper) at one time, and a fixing device 60 configured to fix the secondarily transferred image onto the sheet P. The image forming apparatus 1 also includes a controller 40 configured to control the operation of each of the units and device.

The image forming apparatus 1 is a so-called tandem-type printer. The image forming units 1Y, 1M, 1C, and 1K are sequentially arranged in a line in the order of, from the upstream side of the intermediate transfer belt 15, yellow (Y), magenta (M), cyan (C), and black (B). The image forming units 1Y, 1M, 1C, and 1K have the same structure except that the color of a toner used is different from each other. The structure of the image forming units will be described by taking the image forming unit 1Y, which corresponds to yellow, as a representative example with reference to reference numerals. The image forming unit 1Y includes a photoconductor drum 11 that rotates in the direction shown by arrow A. Around the photoconductor drum 11, a charging device 12 that charges the photoconductor drum 11, a laser exposure device 13 that radiates an exposure beam Bm on the photoconductor drum 11 to write an electrostatic latent image, a developing device 14 that contains a yellow toner and develops the electrostatic latent image on the photoconductor drum 11 with the toner, the first transfer unit 10 that transfers a toner image of the corresponding color component formed on the photoconductor drum 11 onto the intermediate transfer belt 15, and a drum cleaner 17 that removes the toner remaining on the photoconductor drum 11 are sequentially provided.

The intermediate transfer belt 15 is a film-like endless belt composed of a material obtained by incorporating an antistatic agent in a resin. Examples of the resin include polyimides and polyamides. An example of the antistatic agent incorporated in such a resin is carbon black. The intermediate transfer belt 15 has a volume resistivity of 10⁶ Ωcm or more and 10¹⁴ Ωcm or less, and a thickness of, for example, about 0.1 mm. The intermediate transfer belt 15 is arranged around multiple rolls and circularly moves in the direction shown by arrow B in FIG. 1. The rolls around which the intermediate transfer belt 15 is arranged are a driving roll 31 that drives the intermediate transfer belt 15, a support roll 32 that supports both ends of an area where the intermediate transfer belt 15 extends along the arrangement of the photoconductor drums 11, a tension roll 33 that provides a constant tension to the intermediate transfer belt 15, a back-up roll 25 provided in the second transfer unit 20, and a cleaning back-up roll 34 provided in a cleaning unit. The driving roll 31 is driven by a motor (not shown) and circularly moves the intermediate transfer belt 15 at a predetermined speed. The tension roll 33 also functions as a correction roll that prevents the intermediate transfer belt 15 from meandering.

Each of the first transfer units 10 includes a first transfer roll 16 arranged so as to face the photoconductor drum 11 with the intermediate transfer belt 15 therebetween. The first transfer roll 16 includes a shaft and a sponge layer fixed around the shaft and functioning as an elastic layer. The shaft is a cylindrical bar composed of a metal. The metal constituting this shaft is typically iron or stainless steel (SUS). The sponge layer is composed of a material obtained by incorporating an electrically conductive agent such as carbon black in a blend rubber containing acrylonitrile-butadiene rubber (NBR), styrene-butadiene rubber (SBR), and ethylene-propylene-diene rubber (EPDM), the material having a volume resistivity of 10⁷ Ωcm or more and 10⁹ Ωcm or less. The intermediate transfer belt 15 is sandwiched between the first transfer roll 16 and the photoconductor drum 11. A voltage (first transfer bias) having a polarity opposite to a charging polarity of the toner (negative polarity in this example, hereinafter the same) is applied to the first transfer roll 16. Consequently, toner images on the photoconductor drums 11 of the image forming units 1Y, 1M, 1C, and 1K are sequentially electrostatically attracted onto the intermediate transfer belt 15, thus forming a superimposed toner image on the intermediate transfer belt 15.

The second transfer unit 20 includes the back-up roll 25 and a second transfer roll 22 arranged on the toner-image-carrying surface side of the intermediate transfer belt 15. The back-up roll 25 includes an inner layer composed of EPDM and a tubular surface layer composed of a blend rubber containing EPDM and NBR in which carbon is dispersed. The back-up roll 25 has a surface resistivity of 10⁷ Ω/m² or more and 10¹⁰ Ω/m² or less and a hardness of, for example, about 70° (Asker-C). This back-up roll 25 is arranged on the inner peripheral surface side of the intermediate transfer belt 15, that is, on the side opposite the second transfer roll 22 with the intermediate transfer belt 15 therebetween. The back-up roll 25 forms a counter electrode of the second transfer roll 22. A metallic power supply roll 26 to which a second transfer bias is applied is in contact with the back-up roll 25.

The second transfer roll 22 includes a shaft and a sponge layer covering the periphery of the shaft. The shaft is a cylindrical bar composed of a metal. The metal constituting this shaft is typically iron or stainless steel (SUS). The sponge layer has a cylindrical shape and is composed of a material obtained by incorporating an electrically conductive agent in a blend rubber. This blend rubber is typically a rubber containing NBR, SBR, and EPDM. The electrically conductive agent incorporated in the blend rubber is typically carbon black. The volume resistivity of the sponge layer is 10⁷ Ωcm or more and 10⁹ Ωcm or less. The second transfer roll 22 is pressed onto the back-up roll 25 with the intermediate transfer belt 15 therebetween. The second transfer roll 22 is grounded, and an electric field is formed between the second transfer roll 22 and the back-up roll 25 by the second transfer bias. The second transfer roll 22 secondarily transfers the toner image onto a sheet P transported to the second transfer unit 20 with this electric field.

An intermediate transfer belt cleaner 35 is provided on the downstream side of the second transfer unit 20 in the intermediate transfer belt 15. The intermediate transfer belt cleaner 35 cleans the surface of the intermediate transfer belt 15 by removing a toner and paper dust remaining on the intermediate transfer belt 15 after the second transfer. On the upstream side of the yellow image forming unit 1Y, a reference sensor (home position sensor) 42 that generates a reference signal for adjusting timings of image formation in the image forming units 1Y, 1M, 1C, and 1K is provided. The reference sensor 42 recognizes marks provided on the reverse surface side of the intermediate transfer belt 15 and generates the reference signal. The image forming units 1Y, 1M, 1C, and 1K start image formation in response to instructions from the controller 40 based on this recognition of the reference signal. On the downstream side of the black image forming unit 1K, an image density sensor 43 for adjusting the image quality is provided.

Furthermore, the image forming apparatus 1 includes, as a sheet transport system, a sheet supply unit 50 that supplies the sheets P, a pickup roll 51 that picks up a sheet P stacked in the sheet supply unit 50 at a predetermined timing, transport rolls 52 that transport the sheet P picked up by the pickup roll 51, a guiding member 53 that guides the sheet P transported by the transport rolls 52 to the second transfer unit 20, a transport belt 55 that transports the sheet P after the second transfer performed by the second transfer roll 22 to the fixing device 60, and a fixing entrance guide 56 that guides the sheet P to the fixing device 60.

The fixing device 60 includes a fixing roll 61 and an endless belt 62. The fixing roll 61 is heated, and rotates. The endless belt 62 circularly moves while following the movement of the fixing roll 61. The fixing roll 61 and the endless belt 62 heat and press the sheet P arranged therebetween, thereby fixing an unfixed toner image onto the sheet P. The more detailed structure of the fixing device 60 will be described later.

Next, a fundamental image-forming process of the image forming apparatus 1 will be described.

In the image forming apparatus 1, image data output from a personal computer (PC) (not shown) is subjected to an image processing by an image processing unit (not shown), and is then supplied to the image forming units 1Y, 1M, 1C, and 1K. In the image processing unit, various types of image processing such as shading correction, misregistration correction, brightness/color space conversion, gamma correction, frame erase, color edition, and movement edition are performed on reflectance data input to the image processing unit. The image data obtained after the image processing is converted to color material gradation data of four colors of Y, M, C, and K and supplied to the laser exposure devices 13 of the image forming units 1Y, 1M, 1C, and 1K.

In the laser exposure devices 13, for example, the exposure beam Bm emitted from a semiconductor laser is radiated on the photoconductor drums 11 of the image forming units 1Y, 1M, 1C, and 1K in accordance with the supplied color material gradation data. The surface of each of the photoconductor drums 11 of the image forming units 1Y, 1M, 1C, and 1K is charged by the corresponding charging device 12, and the surface is then scan-exposed by the laser exposure device 13 to form an electrostatic latent image. Electrostatic latent images thus formed are developed as toner images of the respective colors Y, M, C, and K by the developing devices 14 of the image forming units 1Y, 1M, 1C, and 1K. The toner images formed on the photoconductor drums 11 of the image forming units 1Y, 1M, 1C, and 1K are transferred onto the intermediate transfer belt 15 in the first transfer units 10 at which the respective photoconductor drums 11 and the intermediate transfer belt 15 contact each other. More specifically, in each of the first transfer units 10, a voltage (first transfer bias) having a polarity opposite to a charging polarity of the toner (negative polarity) is applied to the intermediate transfer belt 15 by the corresponding first transfer roll 16 to transfer the toner image onto the surface of the intermediate transfer belt 15. The toner images formed in the image forming units 1Y, 1M, 1C, and 1K are sequentially superimposed on the surface of the intermediate transfer belt 15.

The toner images are sequentially transferred onto the surface of the intermediate transfer belt 15 and then transported to the second transfer unit 20 with the movement of the intermediate transfer belt 15. Meanwhile, in the sheet transport system, the pickup roll 51 rotates in accordance with the timing at which the toner images are transported to the second transfer unit 20 to pick up a sheet P stacked in the sheet supply unit 50. The sheet P picked up by the pickup roll 51 is transported by the transport rolls 52, and reaches the second transfer unit 20 through the guiding member 53. Before the sheet P reaches the second transfer unit 20, the sheet P is temporarily stopped. In this step, a registration roll (not shown) rotates in accordance with the timing of the movement of the intermediate transfer belt 15 on which the toner images are carried, thus aligning the position of the sheet P with the position of the toner images.

In the second transfer unit 20, the second transfer roll 22 presses the intermediate transfer belt 15 onto the back-up roll 25. The transported sheet P is sandwiched between the intermediate transfer belt 15 and the second transfer roll 22. A voltage (second transfer bias) having the same polarity as the charging polarity of the toner (negative polarity) is applied to the back-up roll 25 from the power supply roll 26 so that a transfer electric field is formed between the second transfer roll 22 and the back-up roll 25. The toner images carried on the intermediate transfer belt 15 are electrostatically transferred from the intermediate transfer belt 15 onto the sheet P.

The sheet P on which the toner images have been electrostatically transferred is then released from the intermediate transfer belt 15 by the second transfer roll 22 and transported to the transport belt 55 provided on the downstream side of the second transfer roll 22 in the sheet transport direction. The transport belt 55 transports the sheet P to the fixing device 60 in accordance with the transport speed of the fixing device 60. The toner images on the sheet P transported to the fixing device 60 are subjected to a fixing process by heat and pressure in the fixing device 60, thereby being fixed onto the sheet P. The sheet P having the fixed image thereon is transported to a paper output unit (not shown) provided in an output unit of the image forming apparatus 1.

Meanwhile, the toner that is not sufficiently transferred in the second transfer unit 20 from the intermediate transfer belt 15 onto the sheet P and remaining on the intermediate transfer belt 15 is transported to the cleaning unit with the movement of the intermediate transfer belt 15, and is removed from the intermediate transfer belt 15 by the cleaning back-up roll 34 and the intermediate transfer belt cleaner 35.

### Fixing Device

The fixing device 60 constituting the image forming apparatus 1 shown in FIG. 1 will now be described. The fixing device 60 is a fixing device according to an exemplary embodiment of the present invention.

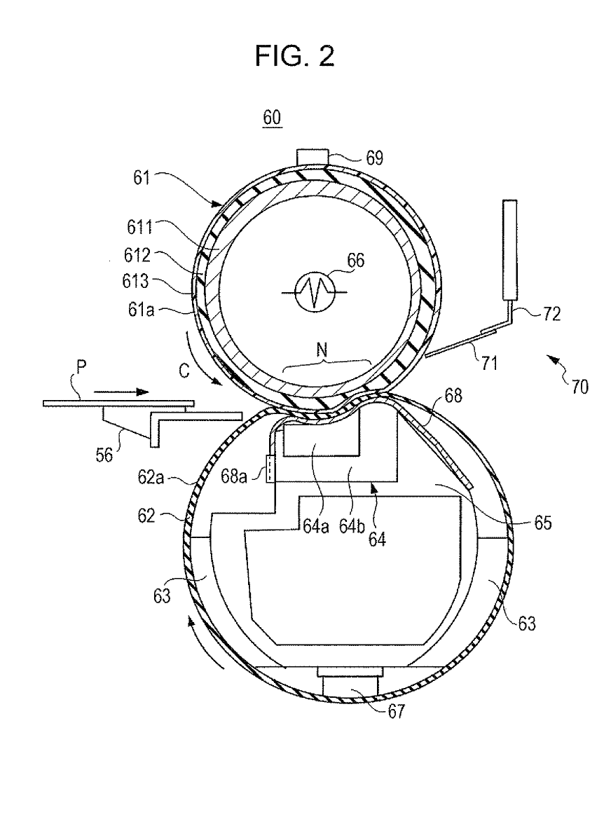

FIG. 2 is a cross-sectional side view showing the structure of the fixing device 60.

The fixing device 60 shown in FIG. 2 includes a fixing roll 61, an endless belt 62, and a pressure pad 64 that presses the endless belt 62 onto the fixing roll 61.

Herein, the fixing roll 61 corresponds to an example of a circularly moving member, the endless belt 62 corresponds to an example of a belt-shaped member, and the pressure pad 64 corresponds to an example of a pressing member according to an exemplary embodiment of the present invention.

The fixing roll 61 is a cylindrical roll including a metal core (cylindrical core bar) 611, a heat-resistant elastic layer 612 provided on the outer periphery of the core 611, and a release layer 613 provided on the outer periphery of the heat-resistant elastic layer 612, and is rotatably supported in the body of the fixing device 60. The fixing roll 61 is a straight roll in which the outer diameter thereof is uniform in a direction of the rotation axis. An outer peripheral surface 61a of the fixing roll 61 circularly moves with the rotation of the fixing roll 61. The moving speed of the outer peripheral surface 61a is, for example, 194 mm/sec.

For example, a halogen heater 66 having a rated power of 600 W is provided as a heat generation source inside the fixing roll 61. A temperature sensor 69 is provided outside the fixing roll 61. The temperature sensor 69 is in contact with the outer peripheral surface of the fixing roll 61. The controller 40 (refer to FIG. 1) of the image forming apparatus controls lighting of the halogen heater 66 on the basis of the temperature value measured with the temperature sensor 69 to maintain the temperature of the outer periphery of the fixing roll 61 to a predetermined temperature (for example, 175° C.).

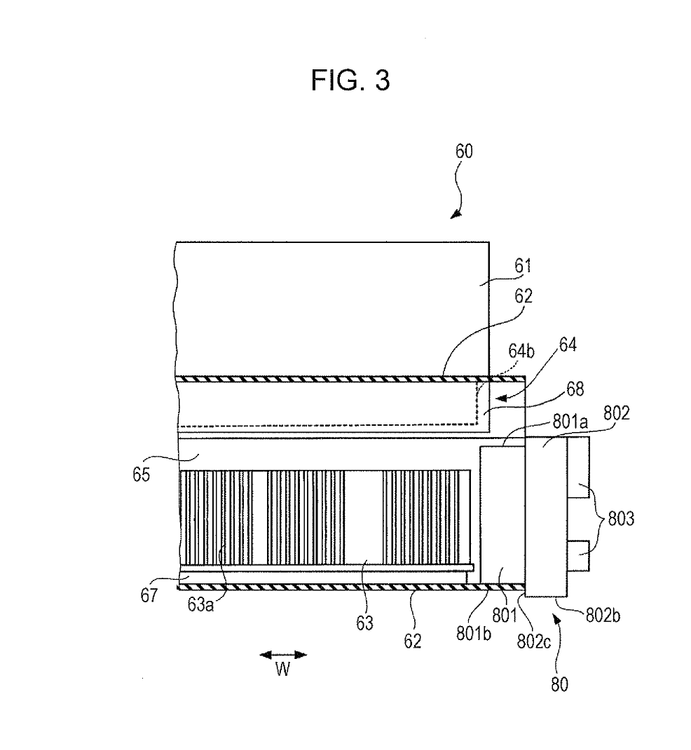

The endless belt 62 has a belt shape or a substantially belt shape, and is formed to be seamless in order to prevent defects from being generated on an output image. A circular movement of the endless belt 62 is freely supported by the pressure pad 64 and a belt guide member 63, which are arranged inside the endless belt 62, and an edge guide member 80 (refer to FIG. 3). The outer peripheral surface of the endless belt 62 is in contact with the outer peripheral surface of the fixing roll 61 in a nip part N, and the endless belt 62 circularly moves with the rotation of the fixing roll 61. More specifically, the endless belt 62 is arranged in contact with the fixing roll 61 so as to apply a pressure to the fixing roll 61, and circularly moves at a predetermined speed (for example, 194 mm/sec) in accordance with the movement of the fixing roll 61.

A release-assisting member 70 that completely separates the sheet P, which has been released from the fixing roll 61, from the fixing roll 61 is provided on the downstream side of the nip part N of the fixing device 60. The release-assisting member 70 includes a baffle holder 72 and a releasing baffle 71 held by the baffle holder 72. The releasing baffle 71 extends toward the fixing roll 61 in a direction opposing the moving direction of the outer peripheral surface of the fixing roll 61 (counter direction), and an end of the releasing baffle 71 is arranged at a position close to the fixing roll 61.

The description of FIG. 2 is temporarily stopped, and the structure for supporting the endless belt 62 will now be described with reference to FIG. 3.

FIG. 3 is a view of a part of the fixing device 60 shown in FIG. 2, viewed from a direction in which a sheet is transported. FIG. 3 shows the structure of the inside of the endless belt 62 that is cut at a halfway position. In the fixing device 60, a direction intersecting the direction of the circular movement of the endless belt 62 is referred to a width direction W. This width direction W is a direction of the rotation axis of the fixing roll 61 shown in FIG. 2.

A holder 65 is arranged inside the endless belt 62, and the edge guide members 80 are provided at both ends of the holder 65 in the width direction W. A deviation of the endless belt 62 in the width direction W is regulated by the edge guide members 80.

Each of the edge guide members 80 includes a belt running guide portion 801 arranged inside the endless belt 62, a flange portion 802 that is arranged outside the endless belt 62 in the width direction W and that regulates the movement of the endless belt 62 in the width direction W, and a holding portion 803 that fixes the edge guide member 80 to the body of the fixing device 60 in position. The holding portion 803 is fixed to the body of the fixing device 60 in position, whereby the holder 65 fixed to the edge guide members 80 and each component supported by this holder 65 is positioned.

In FIG. 3, a side face of the belt running guide portion 801 is shown. When the belt running guide portion 801 is viewed from the right side of FIG. 3, the belt running guide portion 801 has a substantially circular shape that is inscribed in the cross section of the endless belt 62 shown in FIG. 2 except for the nip part N. That is, the belt running guide portion 801 has a substantially cylindrical outer shape. A portion corresponding to the nip part N forms a notch 801a. The inner peripheral surface of the both ends of the endless belt 62 in the width direction W is in contact with an outer peripheral surface 801b of the belt running guide portion 801. The both ends of the endless belt 62 in the width direction W are supported by the corresponding belt running guide portion 801. The belt running guide portion 801 is composed of a material having a coefficient of friction that is low to the extent that the circular movement of the endless belt 62 is not blocked, and having a thermal conductivity lower than that of metals so that heat is not easily drawn from the endless belt 62. The belt running guide portion 801 is composed of, for example, a heat-resistant resin such as a tetrafluoroethylene-perfluoroalkyl vinyl ether copolymer (PFA) or polyphenylene sulfide (PPS).

An outer peripheral surface 802b of the flange portion 802 protrudes from the outer peripheral surface 801b of the belt running guide portion 801. By bringing an edge of the endless belt 62 into contact with a step 802c provided between the flange portion 802 and the belt running guide portion 801, a movement (belt walk) of the endless belt 62 in the width direction W is limited.

The endless belt 62 is supported by the pressure pad 64 and the belt guide member 63 in regions except for the both ends in the width direction W. A part of the inner peripheral surface of the endless belt 62, the part being except for the both ends, is in contact with the pressure pad 64 and the belt guide member 63.

The belt guide member 63 is a member attached to the holder 65 and extending in the width direction W. Multiple ribs 63a extending in a direction of the circular movement of the endless belt 62 are provided on the belt guide member 63 so as to reduce the area where the belt guide member 63 contacts the inner peripheral surface of the endless belt 62. The belt guide member 63 is composed of a material having a coefficient of friction that is low to the extent that the endless belt 62 smoothly circularly moves, and having a thermal conductivity lower than that of metals so that heat is not easily drawn from the endless belt 62. The belt guide member 63 is also composed of a heat-resistant resin such as a tetrafluoroethylene-perfluoroalkyl vinyl ether copolymer (PFA) or polyphenylene sulfide (PPS).

The pressure pad 64 is arranged inside the endless belt 62 and is supported by the holder 65. The pressure pad 64 is attached to the holder 65 with a spring or rubber (not shown) therebetween. The pressure pad 64 presses the endless belt 62 onto the fixing roll 61. By pressing the endless belt 62 onto the fixing roll 61, the nip part N is formed.

Here, a description will be continued with reference to FIG. 2 again. The pressure pad 64 includes a pre-nip member 64a and a releasing nip member 64b. The pre-nip member 64a presses the endless belt 62 onto the fixing roll 61 at the entrance side (the upstream side in the transport direction of the sheet) of the nip part N. The releasing nip member 64b presses the endless belt 62 onto the fixing roll 61 at the exit side (the downstream side) of the nip part N. A surface of the pre-nip member 64a, the surface facing the fixing roll 61, has a concave shape conforming to the shape of the outer peripheral surface of the fixing roll 61. Therefore, a wide nip part N is formed, as compared with the case where the surface of the pre-nip member 64a has a flat shape. A surface of the releasing nip member 64b, the surface facing the fixing roll 61, has a convex shape, and the releasing nip member 64b protrudes toward the fixing roll 61 with respect to the pre-nip member 64a. Accordingly, the releasing nip member 64b locally presses the surface of the fixing roll 61 at the exit side (downstream side) of the nip part N so as to smooth the surface of a toner image on the sheet passing through the nip part N and provide image gloss. In addition, when the releasing nip member 64b locally presses the surface of the fixing roll 61, a depression is formed on the surface of the fixing roll 61. Consequently, a down-curl, which is a curve in the downward direction, is formed on the sheet P, and thus the sheet P is easily released from the fixing roll 61 after passing through the nip part N.

Furthermore, in order to reduce sliding friction between the inner peripheral surface of the endless belt 62 and the pressure pad 64, a low-friction sheet 68 is provided on a surface of the pressure pad 64, the surface contacting the endless belt 62. The low-friction sheet 68 according to this exemplary embodiment is arranged, as a part of the pressure pad 64, at a position facing the fixing roll 61 with the endless belt 62 therebetween. The low-friction sheet 68 covers a surface of the pre-nip member 64a and the releasing nip member 64b of the pressure pad 64, the surface facing the fixing roll 61. The low-friction sheet 68 is sandwiched between the endless belt 62 and the pre-nip member 64a and releasing nip member 64b. The low-friction sheet 68 is pressed onto the endless belt 62 by the pre-nip member 64a and the releasing nip member 64b.

Herein, the combination of the pre-nip member 64a and the releasing nip member 64b in the pressure pad 64 corresponds to an example of a base according to an exemplary embodiment of the present invention, and the low-friction sheet 68 corresponds to an example of a lubricant dispersion member according to an exemplary embodiment of the present invention.

An end of the low-friction sheet 68 at the upstream side of the nip part N in the moving direction of the endless belt 62 is fixed to the releasing nip member 64b using a low-friction-sheet-fixing member 68a. In the low-friction sheet 68, a part at the downstream side of the end fixed to the releasing nip member 64b, i.e., a part including the region of the nip part N, is not fixed to the pre-nip member 64a or the releasing nip member 64b. The part of the low-friction sheet 68 is supported at a position between the endless belt 62 and the pre-nip member 64a and releasing nip member 64b by being sandwiched between the endless belt 62 and the pre-nip member 64a and releasing nip member 64b. In the low-friction sheet 68, since the part including the region of the nip part N is not fixed to the pre-nip member 64a or the releasing nip member 64b, formation of wrinkles due to deformation of the pre-nip member 64a and the releasing nip member 64b is prevented in the low-friction sheet 68.

The low-friction sheet 68 is a member separate from the pre-nip member 64a and the releasing nip member 64b. Accordingly, even if a pressing force of the pre-nip member 64a and the releasing nip member 64b toward the endless belt 62 becomes locally uneven, the low-friction sheet 68, which is interposed between the endless belt 62 and the pre-nip member 64a and releasing nip member 64b and which two-dimensionally contacts the inner peripheral surface of the endless belt 62, disperses and equalizes the pressing force.

The low-friction sheet 68 contains a lubricant therein. When the low-friction sheet 68 is worn, the lubricant is exposed to the surface of the low-friction sheet 68. This lubricant is applied onto the inner peripheral surface of the endless belt 62 and supplied to the surface on which the inner peripheral surface of the endless belt 62 and the low-friction sheet 68 contact each other, whereby the frictional resistance between the inner peripheral surface of the endless belt 62 and the pressure pad 64 is reduced.

The low-friction sheet 68 is arranged, as a part of the pressure pad 64 that presses the endless belt 62 onto the fixing roll 61, at a position facing the fixing roll 61 with the endless belt 62 therebetween. Accordingly, the pressing force of the endless belt 62 to the fixing roll 61 is used as a pressing force for wearing the low-friction sheet 68, the pressing force being applied to the endless belt 62. This pressing force is a stable force, and thus the wear of the low-friction sheet 68 provided on the pressure pad 64 is also stable.

The low-friction sheet 68 covers the pre-nip member 64a and the releasing nip member 64b, and is a member separate from the pre-nip member 64a and the releasing nip member 64b. That is, a function of pressing the endless belt 62 onto the fixing roll 61 and a function of supplying a lubricant are separately provided to the pre-nip member 64a and releasing nip member 64b, and the low-friction sheet 68, respectively. The pre-nip member 64a and releasing nip member 64b, and the low-friction sheet 68 are separately produced in accordance with their function. The structure of the low-friction sheet 68 containing a lubricant therein will be described later.

A lubricant application member 67 that supplies a lubricant separately from the low-friction sheet 68 is provided under the belt guide member 63. The lubricant application member 67 extends in the width direction W shown in FIG. 3 and is in contact with the inner peripheral surface of the endless belt 62. The lubricant application member 67 is prepared by incorporating a lubricant having a kinematic viscosity of 300 cSt (10⁻⁶ m²/s) or more in glass fibers. In the fixing device 60 of this exemplary embodiment, as described below, with the wear of the low-friction sheet 68, a lubricant is released from the low-friction sheet 68. The lubricant application member 67 compensates for a temporary shortage of a lubricant in an initial state before a surface layer 68A of the low-friction sheet 68 starts to be worn after the factory shipment, for example. In order to compensate for a temporary shortage of a lubricant in an initial state, a small amount of a lubricant may be applied onto the surface of the low-friction sheet 68, instead of providing the lubricant application member 67.

### Basic Operation of Fixing Device

Before respective members are described in more detail, a basic operation of the fixing device 60 will now be described. The fixing roll 61 is connected to a driving motor (not shown) and rotates in the direction shown by arrow C. The endless belt 62 moves in accordance with the movement of the fixing roll 61 in the same direction as the direction in which the outer peripheral surface of the fixing roll 61 moves in the nip part N. The sheet P on which a toner image has been electrostatically transferred in the second transfer unit 20 (refer to FIG. 1) of the image forming apparatus 1 is guided to the fixing entrance guide 56 and transported to the nip part N. When the sheet P passes through the nip part N, the toner image on the sheet P is fixed on the sheet P by heat supplied from the fixing roll 61 and a pressure applied by being sandwiched between the fixing roll 61 and the endless belt 62. In the fixing device 60, since the pre-nip member 64a has a concave shape, the nip part N is widely formed, as compared with the case where the pre-nip member 64a has a flat shape. Accordingly, heat and the pressure are applied for a long time, thus stabilizing a fixing performance. The sheet P passing through the nip part N is released from the fixing roll 61 and guided to a paper output path by the release-assisting member 70.

### Structures of Members in Fixing Device

Next, respective members constituting the fixing device 60 will be described.

The core 611 of the fixing roll 61 is a cylindrical member composed of a metal, alloy, or ceramic having a high thermal conductivity, typically for example, iron, aluminum (e.g., A-5052), SUS, or copper. The core 611 has, for example, an outer diameter φ of 30 mm, a wall thickness of 1.8 mm, and a length of 360 mm.

The heat-resistant elastic layer 612 is composed of an elastic material having high heat resistance so that the heat-resistant elastic layer 612 withstands the temperature during fixing. For example, a rubber or an elastomer having a rubber hardness of 15° or more and 45° or less (JIS-A) is used as the elastic material. Specifically, a silicone rubber, a fluorine-containing rubber, or the like may be used as the heat-resistant elastic layer 612. Among these elastic materials, silicone rubbers have a low surface tension and good elasticity. Examples of the silicone rubbers include room temperature vulcanization (RTV) silicone rubbers and high-temperature vulcanization (HTV) silicone rubbers. Specific examples thereof include polydimethyl silicone rubber (MQ), methyl vinyl silicone rubber (VMQ), methyl phenyl silicone rubber (PMQ), and fluorosilicone rubber (FVMQ). In the fixing device 60 of this exemplary embodiment, the core 611 is covered with an HTV silicone rubber having a rubber hardness of 35° (JIS-A) and a thickness of 600 μm. The thickness of the heat-resistant elastic layer 612 is usually 3 mm or less, and preferably in the range of 0.1 mm to 1.5 mm. The method for forming the heat-resistant elastic layer 612 around the core 611 is not particularly limited. For example, a known coating method or molding method may be employed.

Since the release layer 613 is provided on the outer peripheral surface of the heat-resistant elastic layer 612 of the fixing roll 61, an offset phenomenon in which a toner image adheres to the outer peripheral surface of the fixing roll 61 is prevented. The material of the release layer 613 is not particularly limited as long as the material exhibits an appropriate releasing property to a toner image. Examples thereof include fluorine-containing rubbers, silicone rubbers, and fluorocarbon resins. Among these materials, fluorocarbon resins are preferable. Examples of the fluorocarbon resin include polytetrafluoroethylene (PTFE); and tetrafluoroethylene-perfluoroalkyl vinyl ether copolymers (PFA) such as a tetrafluoroethylene-perfluoromethyl vinyl ether copolymer (MFA), a tetrafluoroethylene-perfluoroethyl vinyl ether copolymer (EFA), and a tetrafluoroethylene-perfluoropropyl vinyl ether copolymer. Examples thereof further include a tetrafluoroethylene-hexafluoropropylene copolymer (FEP), an ethylene-tetrafluoroethylene copolymer (ETFE), polyvinylidene fluoride (PVDF), polychlorotrifluoroethylene (PCTFE), and polyvinyl fluoride (PVF). Among these fluorocarbon resins, in particular, polytetrafluoroethylene (PTFE) and tetrafluoroethylene-perfluoroalkyl vinyl ether copolymers (PFA) are preferably used from the standpoint of heat resistance and mechanical properties.

The thickness of the release layer 613 is usually in the range of 10 to 50 μm, and preferably in the range of 15 to 30 μm. The method for forming the release layer 613 is not limited to a particular method. For example, the coating method mentioned above may be employed. Alternatively, a method including covering with a tube formed by extrusion may be employed. In the fixing device 60 of this exemplary embodiment, the heat-resistant elastic layer 612 is covered with a PFA having a thickness of 30 μm.

The endless belt 62 is formed to be seamless so that defects are not generated on an output image. The endless belt 62 includes a base layer and a release layer (surface layer) coating a surface (outer peripheral surface), the surface being located at the fixing roll 61 side of the base layer, or coating each surface of the base layer. From the standpoint of heat resistance and mechanical properties, one or a mixture containing two or more resins selected from, for example, thermosetting polyimide resins, thermoplastic polyimide resins, polyamide resins, polyamide-imide resins, and polybenzimidazole resins are preferably used.

A fluorocarbon resin is used as a release layer (surface layer) coating at least one surface of the base layer. Examples of the fluorocarbon resin include, but are not particularly limited to, polytetrafluoroethylene (PTFE); and tetrafluoroethylene-perfluoroalkyl vinyl ether copolymers (PFA) such as a tetrafluoroethylene-perfluoromethyl vinyl ether copolymer (MFA), tetrafluoroethylene-perfluoroethyl vinyl ether copolymer (EFA), and a tetrafluoroethylene-perfluoropropyl vinyl ether copolymer. Examples thereof further include a tetrafluoroethylene-hexafluoropropylene copolymer (FEP), an ethylene-tetrafluoroethylene copolymer (ETFE), polyvinylidene fluoride (PVDF), polychlorotrifluoroethylene (PCTFE), and polyvinyl fluoride (PVF). Among these fluorocarbon resins, polytetrafluoroethylene (PTFE) and tetrafluoroethylene-perfluoroalkyl vinyl ether copolymers (PFA) have good heat resistance or good mechanical properties. The thickness of the release layer (surface layer) is usually 5 μm or more and 100 μm or less, and preferably 10 μm or more and 30 μm or less.

The pressure pad 64 presses the endless belt 62 onto the fixing roll 61 with a load of, for example, 343 N (35 kgf). The pre-nip member 64a and the releasing nip member 64b of the pressure pad 64 are usually composed of a material having a JIS-A hardness of 10° or more and 40° or less. However, materials having a hardness outside this range may also be used. The pre-nip member 64a is composed of, for example, a silicone rubber having a width of 5 mm, a thickness of 5 mm, and a length of 320 mm. However, not only a silicone rubber but also a plate spring, another elastic material such as a fluorine-containing rubber, or the like may also be used as the material of the pre-nip member 64a. A surface of the pre-nip member 64a, the surface facing the fixing roll 61, has a concave shape.

The releasing nip member 64b is composed of a heat-resistant resin such as PPS, a polyimide, a polyester, or a polyimide, or a metal such as iron, aluminum, or SUS. A surface of the releasing nip member 64b, the surface facing the fixing roll 61, has a convex shape having a substantially uniform radius of curvature.

The endless belt 62 that is pressed onto the fixing roll 61 by the pressure pad 64 is wound on the fixing roll 61 with a winding angle of about 25° to form the nip part N. A length of the nip part N in the sheet transport direction (i.e., nip width) is about 6 mm.

### Structure of Low-Friction Sheet

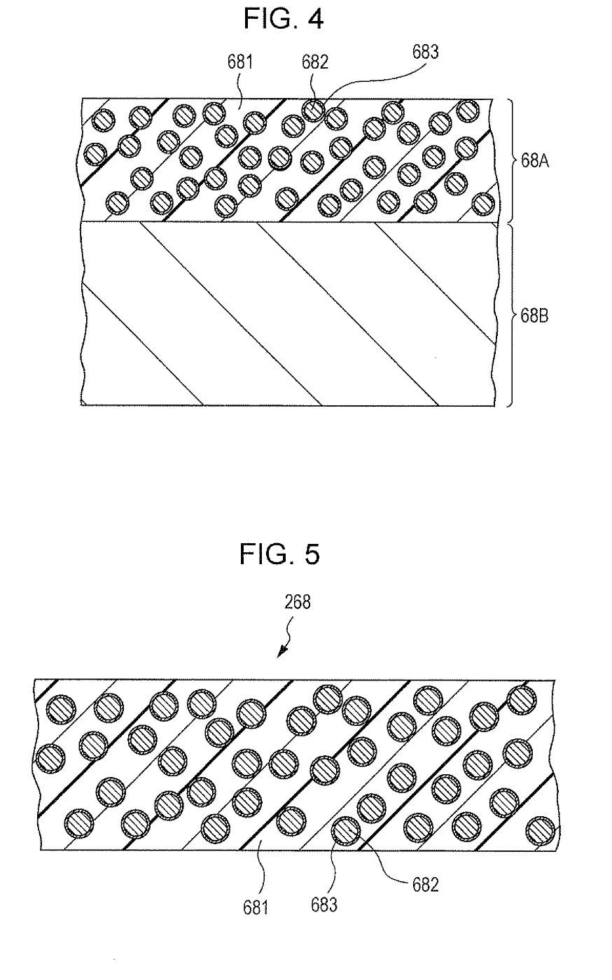

FIG. 4 is a partial cross-sectional view showing the structure of the low-friction sheet 68.

The low-friction sheet 68 includes a surface layer 68A and a base layer 68B supporting the surface layer 68A.

The surface layer 68A includes a heat-resistant resin 681 which is a solid material and a lubricant 682 which is dispersed in this heat-resistant resin 681 in the form of particles. The lubricant 682 is exposed to a surface when the surface layer 68A of the low-friction sheet 68 is worn. More specifically, microcapsules 683 which are particulate containers are dispersed in the heat-resistant resin 681, and the lubricant 682 is encapsulated in the microcapsules 683. A state in which the lubricant 682 is dispersed in the form of particles means that particulate lubricant 682 are separated from each other. The particulate lubricant 682 are separated from each other by the microcapsules 683 and the heat-resistant resin 681. The heat-resistant resin 681 is, for example, a polyimide resin, a polyamide resin, or a polyamide-imide resin. As described above, the low-friction sheet 68 is a member separate from the pre-nip member 64a and the releasing nip member 64b, and a part of the low-friction sheet 68, the part being pressed onto the endless belt 62, is not fixed to the pre-nip member 64a or the releasing nip member 64b. Therefore, wrinkles or breaking of the low-friction sheet 68 caused by deformation of the pre-nip member 64a and the releasing nip member 64b does not tend to generate, as compared with the case where the low-friction sheet 68 is integrally formed with the pre-nip member 64a and the releasing nip member 64b by coating, for example. Furthermore, since the low-friction sheet 68 is a member separate from the pre-nip member 64a and the releasing nip member 64b, even if deformation of the pre-nip member 64a and the releasing nip member 64b becomes locally uneven, the low-friction sheet 68 is deformed into a shape conforming to the inner peripheral surface of the endless belt 62, evenly contacts the inner peripheral surface of the endless belt 62, and is evenly worn, as compared with the case where the low-friction sheet 68 is integrally formed with these members 64a and 64b, for example.

Herein, the surface layer 68A corresponds to an example of a wear layer according to an exemplary embodiment of the present invention, and the base layer 68B corresponds to an example of a supporting layer according to an exemplary embodiment of the present invention.

As the lubricant 682, a material that has durability to withstand long-term use under the environment at a fixing temperature and that maintains wettability with the inner peripheral surface of the endless belt 62 is used. Examples of the material of the lubricant 682 include a liquid lubricating oil and semi-solid grease containing a base oil and a thickener. The lubricant 682 encapsulated in the microcapsule 683 may be the same as or different from a lubricant contained in the lubricant application member 67. However, when an oil having a kinematic viscosity (hereinafter, simply referred to as viscosity) of 50 cSt or more and 300 cSt or less, or about 50 cSt or more and about 300 cSt or less is used as the lubricant 682, an increase in a torque after a lapse of time, which is a driving torque of the endless belt 62 after long-term use, is suppressed.

Examples of the lubricant 682 include liquid oils such as silicone oil and fluorine oil, synthetic lubricating oil grease prepared by mixing a solid substance and a liquid, and combinations of these. Examples of the silicone oil include dimethyl silicone oil, organometallic salt-added dimethyl silicone oil, hindered amine-added dimethyl silicone oil, organometallic salt- and hindered amine-added dimethyl silicone oil, methyl phenyl silicone oil, amino-modified silicone oil, organometallic salt-added amino-modified silicone oil, hindered amine-added amino-modified silicone oil, carboxy-modified silicone oil, silanol-modified silicone oil, and sulfonic acid-modified silicone oil. Examples of the fluorine oil include perfluoropolyether oil and modified perfluoropolyether oil.

Examples of the material of the microcapsule 683 include resin compositions containing a heat-resistant thermoplastic resin and a thermosetting resin. Examples of the thermoplastic resin include polyphenylene sulfide, tetrafluoroethylene resins, polysulfones, and polybenzimidazole resins. Examples of the thermosetting resin include polyamide-imide resins, polyimide resins, polyamide resins, phenolic resins, and epoxy resins. The method for producing the microcapsule is selected from known methods in consideration of the combination and characteristics of the material of the lubricant 682 and the material of the microcapsule 683, and the particle diameter of the microcapsule 683. Specifically, examples of the method include chemical preparation methods such as an interfacial polymerization method, an in-situ polymerization method, and an in-liquid hardening coating method; and physico-chemical preparation methods such as a coacervation method, an in-liquid-drying method, and a spray drying method.

After film formation and drying, the surface layer 68A has a thickness double the particle diameter of the microcapsule 683 or more, or about double the particle diameter of the microcapsule 683 or more. Accordingly, the height when two microcapsules 683 overlap is substantially equal to or smaller than the thickness of the surface layer 68A, and unevenness of the surface layer 68A due to the shape of the microcapsules 683 themselves are prevented. Furthermore, since the thickness of the surface layer 68A is double the particle diameter or more or about double the particle diameter or more, in the formation of the surface layer 68A, uneven distribution of the microcapsules 683 incorporated in the heat-resistant resin 681, the uneven distribution being due to sedimentation of the microcapsules 683, is suppressed, as compared with the case where the thickness of the surface layer 68A is less than double the particle diameter or less than about double the particle diameter. However, when the particle diameter of the microcapsules 683 is extremely small, in the production, the microcapsules 683 are not easily dispersed in the heat-resistant resin 681, and the amount of lubricant 682 encapsulated is decreased, thereby decreasing the lubricating effect.

For example, the microcapsules 683 encapsulating the lubricant 682 are prepared by encapsulating amino-modified silicone oil (KF8009A manufactured by Shin-Etsu Chemical Co., Ltd.) having a viscosity of 300 cSt in polyimide-imide resin microcapsules having an average particle diameter of 5 μm by an interfacial polymerization method.

As for the ratio of the microcapsule 683 encapsulating the lubricant 682 to the heat-resistant resin 681 in the surface layer 68A, the microcapsule 683 encapsulating the lubricant 682 is 1 part by weight or more and 50 parts by weight or less, or about 1 part by weight or more and about 50 parts by weight or less relative to 100 parts by weight of the heat-resistant resin 681. When the ratio of the microcapsule 683 is 50 parts by weight or less, cracking of the surface layer 68A may be suppressed when the surface layer 68A is deformed by being pressed onto the endless belt 62. The ratio is adjusted within the above range in consideration of the period of use, use conditions, the type and the amount of lubricant, the particle diameter of the microcapsule 683, and the thickness of the surface layer 68A. Also, the distribution ratio of the microcapsule 683 on the surface side of the surface layer 68A may be increased so as to compensate for a temporary shortage of the lubricant in the initial state in which the surface layer 68A starts to wear. However, from the standpoint of further improving the strength of the surface layer 68A against cracking and more evenly applying the lubricant onto the surface layer 68A, the ratio is preferably 3 parts by weight or more and 30 parts by weight or less, and more preferably 5 parts by weight or more and 20 parts by weight or less.

The base layer 68B functioning as a base portion of the low-friction sheet 68 is composed of a material stronger than the upper surface layer 68A. The base layer 68B is, for example, a glass fiber sheet. The low-friction sheet 68 including the surface layer 68A and the base layer 68B is produced by, for example, applying, onto the base layer 68B, a liquid heat-resistant resin in which the lubricant 682 is dispersed, and curing this heat-resistant resin. Alternatively, the low-friction sheet 68 may be formed by bonding a cured heat-resistant resin to the base layer 68B instead of applying a liquid heat-resistant resin.

The surface layer 68A of the low-friction sheet 68 has a structure in which the lubricant 682 is dispersed in the heat-resistant resin 681 in order to stably supply the lubricant, and thus has a lower mechanical strength than that of a structure including only the heat-resistant resin. However, since the low-friction sheet 68 includes the surface layer 68A and the base layer 68B stronger than the surface layer 68A, the strength of the low-friction sheet 68 increases as a whole, and breaking and the formation of wrinkles are suppressed. In addition, since the strength of the low-friction sheet 68 increases, even if the pressing force of the pre-nip member 64a and the releasing nip member 64b (refer to FIG. 2) toward the endless belt 62 becomes locally uneven, the low-friction sheet 68 easily contacts the inner peripheral surface of the endless belt 62 in accordance with the movement of the endless belt 62 to suppress a variation in the wear of the surface layer 68A, as compared with the case where the low-friction sheet 68 does not include the base layer 68B.

In the fixing device 60, when the endless belt 62 circularly moves, the heat-resistant resin 681 of the surface layer 68A of the low-friction sheet 68 pressed onto the endless belt 62 is rubbed on the inner peripheral surface of the endless belt 62 and worn. Microcapsules 683 exposed to a contact surface of the surface layer 68A are broken by this wear to release the encapsulated lubricant 682. The released lubricant 682 appears on the surface of the heat-resistant resin 681 of the surface layer 68A, the surface being in contact with the inner peripheral surface of the endless belt 62. As a result, a frictional force generated between the low-friction sheet 68 provided on the pressure pad 64 and the inner peripheral surface of the endless belt 62 is decreased by the lubricant, thereby decreasing the resistance caused by the frictional force in the circular movement of the endless belt 62 pressed onto the pressure pad 64.

The microcapsules 683 encapsulating the lubricant 682 are dispersed over the entire surface layer 68A of the low-friction sheet 68. With the wear of the surface layer 68A by friction, microcapsules 683 are sequentially and slowly broken in the order from microcapsules located on the surface to microcapsules located at the deeper position. Accordingly, as long as the endless belt 62 circularly moves, the lubricant is continued to be supplied to the surface of the low-friction sheet 68 for a long time until the thickness of the surface layer 68A is substantially reduced to the particle diameter of the microcapsules 683 by friction. The amount of lubricant supplied by the low-friction sheet 68 depends not on the total amount of the lubricant 682 contained in the low-friction sheet 68, but on the amount of wear of the surface layer 68A. Therefore, the supply of the lubricant is maintained from the start of wear of the surface layer 68A to before the wear-out thereof, and the amount of supply is stabilized. Consequently, a variation in the frictional resistance may also be suppressed, wrinkles of a sheet and image misregistration caused by an increase in the frictional resistance may be suppressed for a long time, and thus reliability may be maintained for a long time.

If the lubricant is supplied not by the low-friction sheet in which the particulate lubricant 682 is dispersed but by, for example, glass fibers impregnated with the lubricant, the amount of lubricant supplied depends on the total amount of lubricant contained in the glass fibers, and thus the amount of supply decreases as time goes on. In addition, the consumption of the lubricant contained in glass fibers is faster than that in the case where the low-friction sheet in which the particulate lubricant is dispersed is used. Accordingly, a dry state, in which the lubricant is not sufficiently supplied onto the inner peripheral surface of the endless belt, is generated within a short time. As a result, the frictional resistance increases, and the endless belt is worn. When the amount of lubricant impregnated into glass fibers is increased to the extent that the dry state of the lubricant is prevented, an excessive amount of lubricant oozes from the glass fibers and adheres to a component, such as a fixing roll, other than the endless belt, which may result in deformation or detachment of an elastic layer on the surface of the roll. Furthermore, when a lubricant is impregnated into glass fibers, a lubricant having a viscosity of 300 cSt or less or about 300 cSt or less cannot be used in order to prevent the lubricant from excessively oozing from the glass fibers.

Alternatively, the amount of lubricant applied may be controlled by bringing glass fibers impregnated with a lubricant or a solid lubricant into contact with the endless belt, and separating the glass fibers or the solid lubricant from the endless belt. However, in this case, the structure of such a device becomes complicated because it is necessary to provide a mechanism for appropriately performing the contact and separation, a driving mechanism of the above-mentioned mechanism, and a control mechanism of the above-mentioned mechanism.

In contrast, in the low-friction sheet 68 of this exemplary embodiment, the lubricant 682 is contained in the surface layer 68A of the low-friction sheet 68 in such a manner that the lubricant 682 is dispersed in the form of particles, and is slowly released by the wear of the surface layer 68A. Accordingly, the amount of lubricant supplied is stabilized, as compared with the case where glass fibers impregnated with a lubricant are used, for example. Furthermore, when glass fibers are used, a lubricant having a kinematic viscosity of 300 cSt or more or about 300 cSt or more is used so as to stably supply the lubricant. In contrast, since excessive oozing does not occur in the low-friction sheet 68 of this exemplary embodiment, a lubricant having high lubricity and having a viscosity of 300 cSt or less or about 300 cSt or less may be used without disturbing a stable supply. In addition, the amount of lubricant supplied is stabilized by a simple mechanism, as compared with the case where glass fibers or a solid lubricant is brought into contact with the endless belt, and separated from the endless belt.

### Second Exemplary Embodiment

In the exemplary embodiment described above, the low-friction sheet 68 has a two-layer structure including the surface layer 68A and the base layer 68B. Next, in a second exemplary embodiment, a low-friction sheet having a single-layer structure will be described. In the description of the second exemplary embodiment, components the same as those in the exemplary embodiment described above are assigned the same reference numerals, and a difference from the above exemplary embodiment will be described.

FIG. 5 is a partial cross-sectional view showing the structure of a low-friction sheet according to the second exemplary embodiment.

A low-friction sheet 268 shown in FIG. 5 has a single-layer structure including a heat-resistant resin 681 in which a lubricant 682 is dispersed in the form of particles, and has no base layer. The lubricant 682 is encapsulated in microcapsules 683 which are particulate containers, and these microcapsules 683 are dispersed in the heat-resistant resin 681.

Also in a fixing device equipped with the low-friction sheet 268 shown in FIG. 5, the heat-resistant resin 681 of the low-friction sheet 268 pressed onto the endless belt 62 (refer to FIG. 2) is worn by being rubbed on the inner peripheral surface of the endless belt 62. Microcapsules 683 exposed to a contact surface of the low-friction sheet 268 are broken by this wear to release the encapsulated lubricant 682. The released lubricant 682 appears on the surface of the heat-resistant resin 681, the surface being in contact with the inner peripheral surface of the endless belt 62.

### EXAMPLES

The above exemplary embodiments will be described more specifically on the basis of Examples. It should be understood that the exemplary embodiments are not limited to Examples.

Image forming apparatuses (color printer DCC400 manufactured by Fuji Xerox Co., Ltd.) each equipped with a fixing device having the same structure as that of the fixing device 60 described in the first exemplary embodiment or the second exemplary embodiment are prepared. In Examples and Comparative Examples, a method of supplying a lubricant to an endless belt and the type of lubricant are changed. An evaluation of an image quality on a sheet and measurement of a driving torque of a fixing roll are conducted using the image forming apparatuses.

### 1. Specification of Device

In the fixing devices of Examples and Comparative Examples, the specifications of common parts other than a low-friction sheet and a lubricant are as follows.

A fixing roll has the following structure. On the outer peripheral surface of a cylindrical iron core having an outer diameter of 26 mm, a wall thickness of 1.8 mm, and a length of 360 mm, an elastic layer composed of a silicone HTV rubber (rubber hardness: 33 degrees, JIS-A) having a thickness of 600 μm is provided. The surface of this elastic layer is covered with a tube composed of a tetrafluoroethylene-perfluoroalkyl vinyl ether copolymer (PFA) and having a thickness of 25 μm, the tube functioning as a release layer. The fixing roll has a surface close to a mirror-finished surface. A halogen lamp (600 W) is provided as a heating source inside the core of the fixing roll. The surface temperature of the fixing roll is controlled to be 175° C. with a temperature sensor and a temperature controller.

An endless belt is composed of a base material of a thermosetting polyimide resin having a perimeter of 94 mm, a thickness of 80 μm, and a width of 344 mm. A release layer is formed by coating the outer peripheral surface of the base material with a tetrafluoroethylene-perfluoroalkyl vinyl ether copolymer (PFA) so as to have a thickness of 30 μm.

A pre-nip member of a pressure pad pressing the endless belt is composed of a silicone rubber having a width of 5 mm, a thickness of 5 mm, and a length of 340 mm. A low-friction sheet is provided so as to cover the silicone rubber. Onto the surface of the low-friction sheet, 0.3 cc of an amino-modified silicone oil (KF8009A manufactured by Shin-Etsu Chemical Co., Ltd.) having a viscosity of 300 cSt is applied as a lubricant in advance. The low-friction sheet has a width of 340 mm and a length of 60 mm. The pressure pad presses the endless belt onto the fixing roll with a load of 34.5 kg.

The winding angle of the endless belt with respect to the fixing roll is about 25°, and the width of a nip part is about 6 mm. The moving speeds of the outer peripheral surface of the fixing roll and the endless belt are each 194 mm/sec.

### 2. Image Quality Evaluation

In the image quality evaluation, a full-color solid image is output on a sheet using each of the apparatuses of Examples and Comparative Examples. The image quality is evaluated in accordance with the criteria below.

### (Evaluation Criteria of Image Quality)

A: No image defects are observed.

B: Image defects are slightly observed, but the image defects do not cause a problem in practical use.

C: Image defects that cause a problem in practical use are generated.

### 3. Measurement of Driving Torque

Torques (unit: N·m) necessary for initial driving and driving after a lapse of time are measured by fitting a measuring gear of a direct torque meter (in-house device fabricated by Fuji Xerox Co., Ltd.) into a gear portion of the fixing roll. This is because a frictional resistance applied to the endless belt is reflected in the driving torque of the fixing roll. When the driving torque of the fixing roll exceeds 0.9 N·m, an excessive load is applied to a driving gear of the fixing roll, which is a driving source, and a problem occurs in terms of practical use. In particular, examples of a phenomenon that represents such a problem in practical use include generation of wrinkles of a sheet on which an image is to be formed, and generation of an abnormal sound of the gear.

### Example 1

Into 100 parts by weight of a soluble polyimide coating (RIKACOAT SN-20 manufactured by New Japan Chemical Co., Ltd.), 2 parts by weight of microcapsules prepared by encapsulating an amine-modified silicone oil (hereinafter, an amine-modified silicone oil may also be simply referred to as “oil”) having a viscosity of 300 cSt in the above-described microcapsules composed of a polyimide-imide resin are dispersed as lubricant-encapsulating microcapsules. The resulting dispersion is formed into a sheet. Thus, a low-friction sheet having the single-layer structure shown in FIG. 5 is prepared. The low-friction sheet is composed of a polyimide resin in which a lubricant is dispersed in the form of particles, and has a thickness of 70 μm. This low-friction sheet is then arranged on the pressure pad.

Onto a lubricant application member that makes up for supply of the lubricant supplied from the low-friction sheet in the initial state, 1.5 cc of an amine-modified silicone oil having a viscosity of 300 cSt is applied as a lubricant.

Next, a fixing device in which the low-friction sheet is fixed to the pressure pad is installed in an image forming apparatus (color printer DCC400 manufactured by Fuji Xerox Co., Ltd.), and printing is performed up to 200,000 sheets. Measurement of the driving torque and evaluation of the print image quality are performed initially (immediately after the start of printing) and after a lapse of time (after 200,000-sheet printing). Consequently, both in the initial state and after the lapse of time, the driving torque remains stable at 0.4 N·m, and no image quality defect is observed. The printing is further continued up to 300,000 sheets, but no problem occurs.

### Example 2

Into 100 parts by weight of a soluble polyimide coating (RIKACOAT SN-20 manufactured by New Japan Chemical Co., Ltd.), 50 parts by weight of microcapsules prepared by encapsulating an amine-modified silicone oil having a viscosity of 300 cSt in the above-described microcapsules composed of a polyamide-imide resin are dispersed as lubricant-encapsulating microcapsules. The resulting coating is applied onto a thermosetting polyimide sheet (UPILEX S, 75 μm, manufactured by Ube Industries, Ltd.), and a solvent is removed by drying. Thus, a low-friction sheet shown in FIG. 4 is prepared. The low-friction sheet has a thickness of 105 μm and coated with a polyimide resin layer which has a thickness of 30 μm and in which the lubricant is dispersed in the form of particles. This low-friction sheet is then arranged on the pressure pad.

Next, a fixing device in which the low-friction sheet is fixed to the pressure pad is installed in an image forming apparatus (color printer DCC400 manufactured by Fuji Xerox Co., Ltd.), and printing is performed up to 200,000 sheets. Measurement of the driving torque and evaluation of the print image quality are performed initially (immediately after the start of printing) and after a lapse of time (after 200,000-sheet printing). Consequently, the polyimide resin layer of the low-friction sheet is worn, and both in the initial state and after the lapse of time, the driving torque remains stable at 0.39 N·m, and no image quality defect is observed.

### Example 3

The test is conducted under the same conditions as those in Example 1 except that the oil encapsulated in the microcapsules is changed to an amine-modified silicone oil having a viscosity of 200 cSt, and the amount of the microcapsules is changed to 20 parts by weight. The driving torque and the print image quality are examined initially (immediately after the start of printing) and after a lapse of time (after 200,000-sheet printing). Consequently, the polyimide resin layer of the low-friction sheet is worn, and both in the initial state and after the lapse of time, the driving torque remains stable at 0.38 N·m, and no image quality defect is observed. The printing is further continued up to 300,000 sheets, but a problem such as image quality defect does not occur.

### Example 4

The test is conducted under the same conditions as those in Example 1 except that the oil encapsulated in the microcapsules is changed to an amine-modified silicone oil having a viscosity of 50 cSt, and the amount of the microcapsules is changed to 15 parts by weight. The driving torque and the print image quality are examined initially (immediately after the start of printing) and after a lapse of time (after 200,000-sheet printing). Consequently, the polyimide resin layer of the low-friction sheet is worn, and both in the initial state and after the lapse of time, the driving torque remains stable at 0.36 N·m, and no image quality defect is observed. The printing is further continued up to 300,000 sheets, but no problem occurs.

### Example 5

The test is conducted under the same conditions as those in Example 1 except that the oil encapsulated in the microcapsules is changed to an amine-modified silicone oil having a viscosity of 20 cSt, and the amount of the microcapsules is changed to 15 parts by weight. The driving torque and the print image quality are examined initially (immediately after the start of printing) and after a lapse of time (after 200,000-sheet printing). Consequently, the polyimide resin layer of the low-friction sheet is worn, and both in the initial state and after the lapse of time, the driving torque remains stable at 0.45 N·m. Although image defects are slightly generated, there is no problem in practical use. The printing is further continued up to 300,000 sheets, but there is no problem in practical use.

### Example 6

The test is conducted under the same conditions as those in Example 1 except that the oil encapsulated in the microcapsules is changed to an amine-modified silicone oil having a viscosity of 500 cSt, and the amount of the microcapsules is changed to 15 parts by weight. The driving torque and the print image quality are examined initially (immediately after the start of printing) and after a lapse of time (after 200,000-sheet printing). Consequently, the polyimide resin layer of the low-friction sheet is worn, and both in the initial state and after the lapse of time, the driving torque remains stable at 0.5 N·m. Although image defects are slightly generated, there is no problem in practical use. The printing is further continued up to 300,000 sheets, but there is no problem in practical use.

### Comparative Example 1

In contrast to the structure of Example 1, a porous sheet (amount of oil impregnated: 0.21 mg/mm³, surface roughness Rt: 5.9 μm) prepared by impregnating glass fibers with a fluorocarbon resin is used instead of the low-friction sheet in which an oil is dispersed in the form of particles. Furthermore, 0.5 cc of the above-mentioned amine-modified silicone oil is supplied on the porous sheet and incorporated. In a structure in which an oil is supplied on a porous sheet, leak of the oil tends to occur. Accordingly, in Comparative Example 1, an oil having a viscosity of about 300 cSt is used. Furthermore, in order to prevent the leaked oil from adhering to the fixing roll, an oil-absorbing member is provided on an edge of the endless belt.

Next, a fixing device including the porous sheet thus prepared is installed in an image forming apparatus (color printer DCC400 manufactured by Fuji Xerox Co., Ltd.), and printing is performed up to 200,000 sheets. The driving torque and the print image quality are examined initially and after a lapse of time (after 200,000-sheet printing).

Consequently, although no image quality defect is initially observed, image defects are generated with time, and paper wrinkles are also generated on the sheets. The driving torque is initially low, but is increased to 0.9 N·m, which is about double the initial driving torque or more, after the lapse of time.

### Comparative Example 2

On fibers composed of a fluorocarbon resin (Teflon (registered trademark) molding powder: manufactured by Dupont-Mitsui Fluorochemicals Co., Ltd.), a porous fluorocarbon resin film composed of the same type of fluorocarbon resin is laminated to prepare a porous sheet. This porous sheet is then fixed onto the pressure pad. Furthermore, 2.5 cc of the above-mentioned amine-modified silicone oil is supplied to a felt composed of Nomex for supplying a lubricant.

Next, a fixing device including the porous sheet thus prepared is installed in an image forming apparatus (color printer DCC400 manufactured by Fuji Xerox Co., Ltd.), and printing is performed up to 200,000 sheets. The driving torque and the print image quality are examined initially and after a lapse of time (after 200,000-sheet printing). Consequently, no image quality defect is observed, and image defects or paper wrinkles are not generated even after the lapse of time. However, from about 30,000 sheets, excessive oil oozes outside the belt. As a result, a sheet is stained by the oil. Thereafter, the silicone rubber layer of the fixing roll is swollen by the oozed oil, resulting in a partial separation between the silicone rubber and the core of the fixing roll.

Reference Examples in which the Viscosity and the Amount of Oil are Changed

Next, in order to test the lubricity of oils, in the same structure as Comparative Example 1, a test is conducted by changing the amount and the viscosity of oil supplied to the porous sheet. Herein, the viscosity of the oil is measured in accordance with “JIS 28803 Viscosity of liquid-measurement method”.

Table 1 shows the initial torque, the torque after a lapse of time, the presence or absence of image defects, and the occurrence or non-occurrence of oil leakage when the amount oil supplied is 0.5 cc. Table 2 shows the initial torque, the torque after a lapse of time, the presence or absence of image defects, and the occurrence or non-occurrence of oil leakage when the amount oil supplied is 2.5 cc. Note that “K” in Tables 1 and 2 is a symbol representing 1,000.

TABLE 1

| | Amount of oil supplied: 0.5 cc | | | |
|---|---|---|---|---|
| | Initial | | | |
| | torque | Torque after lapse | | |
| | (N · m) | of time (N · m) | Image defects | Oil leakage |
| 20 cSt | 0.4 | 0.85 after several | — | Not |
| | | hundred-sheet | | occurred |
| | | printing (Running | | |
| | | out of oil film | | |
| | | due to low | | |
| | | viscosity) | | |
| 50 cSt | 0.37 | 0.89 | C after 50K | Not |
| | | | sheets | occurred |
| 200 cSt | 0.38 | 0.88 | C after 30K | Not |
| | | | sheets | occurred |
| 300 cSt | 0.4 | 0.9 | C after 20K | Not |
| | | | sheets | occurred |
| 500 cSt | 0.5 | 0.92 | C after 20K | Not |
| | | | sheets | occurred |
| 1,000 cSt | 0.6 | 1.0 | C after 10K | Not |
| | | | sheets | occurred |
| 3,000 cSt | 0.9 | A sheet does not | C immediately | Not |
| | | pass through. | after the | occurred |
| | | | start of | |
| | | | printing | |

TABLE 2

| | Amount of oil supplied: 2.5 cc | | | |
|---|---|---|---|---|
| | Initial | | | |
| | torque | Torque after lapse | | |
| | (N · m) | of time (N · m) | Image defects | Oil leakage |
| 20 cSt | 0.41 | 0.8 after 15K- | C after 15K | Occurred |
| | | sheet printing | sheets | after 200 |
| | | (Running out of | | sheets |
| | | oil film due to | | |
| | | low viscosity) | | |
| 50 cSt | 0.36 | 0.58 | A | Occurred |
| | | | | after 2K |
| | | | | sheets |
| 200 cSt | 0.37 | 0.55 | A | Occurred |
| | | | | after 5K |
| | | | | sheets |
| 300 cSt | 0.4 | 0.66 | A | Occurred |
| | | | | after 30K |
| | | | | sheets |
| 500 cSt | 0.48 | 0.7 | A | Occurred |
| | | | | after 100K |
| | | | | sheets |
| 1,000 cSt | 0.57 | 0.8 | C after 100K | Not |
| | | | sheets | occurred |
| 3,000 cSt | 0.83 | Not measured | C immediately | Not |
| | | | after the | occurred |
| | | | start of | |
| | | | printing | |

As shown in Tables 1 and 2, the lower the viscosity of the oil, the lower the initial torque. However, when the viscosity is lower than 50 cSt, an increase in the torque after operation, the increase being due to the running out of an oil film in the nip part, occurs at an early stage. For example, as shown in Table 1, when the amount of oil supplied is 0.5 cc, after an image is formed on several hundred sheets, the torque is increased to 0.85 N·m.

As for the torque after a lapsed of time, in the case where the viscosity is 50 cSt or more, the lower the viscosity of the oil, the lower the torque after the lapsed of time, and such a lower torque is advantageous in driving. When oil having a viscosity of 300 cSt or less is used, the torque after a lapse of time is 0.9 N·m or less, though image defects are generated when an image is formed on 20,000 sheets or more.

As shown in Table 2, when the amount of oil supplied is 2.5 cc, both the initial torque and the torque after a lapse of time decrease and the generation of image defects is also suppressed, as compared with the case where the amount of supply is 0.5 cc. However, when the viscosity of the oil is 500 cSt or less, oil leakage occurs.

As shown in Tables 1 and 2, an increase in the torque after a lapse of time is suppressed by using an oil having a viscosity of 50 cSt or more and 300 cSt or less. However, in the structure in which an oil is incorporated by supplying to a porous sheet, oil leakage occurs when a large amount of oil is supplied to the extent that the generation of image defects is prevented.

In the exemplary embodiments described above, as an example of the lubricant dispersion member according to an exemplary embodiment of the present invention, the low-friction sheet 68 covering the pre-nip member 64a and the releasing nip member 64b of the pressure pad 64 has been described. However, the lubricant dispersion member is not limited to the low-friction sheet 68 as long as the lubricant dispersion member covers a surface of the pressing member, the surface sliding on the inner peripheral surface of the belt-shaped member. For example, the lubricant dispersion member may be a coating layer that is integrally formed with the pre-nip member 64a and the releasing nip member 64b by applying a material of the coating layer onto the surfaces of the pre-nip member 64a and the releasing nip member 64b.

In the exemplary embodiments described above, as an example of the lubricant dispersion member according to an exemplary embodiment of the present invention, a description has been made of a structure in which a lubricant is encapsulated in the microcapsules 683 and the microcapsules 683 are dispersed in the heat-resistant resin 681. However, the lubricant dispersion member is not particularly limited as long as a lubricant is dispersed in the form of particles. For example, the lubricant dispersion member may have a structure in which a lubricant is dispersed in a solid material without microcapsules therebetween, that is, a structure in which a lubricant is directly sectioned by a solid material.

In the exemplary embodiments described above, as an example of the lubricant dispersion member according to an exemplary embodiment of the present invention, a description has been made of the low-friction sheet 68 that is arranged, as a part of the pressure pad 64, at a position facing the fixing roll 61 with the endless belt 62 therebetween. However, the lubricant dispersion member is not limited thereto. The lubricant dispersion member may be arranged at a position separate from the pressing member as long as the lubricant dispersion member is arranged at a position contacting the inner peripheral surface of the belt-shaped member. For example, the lubricant dispersion member may be arranged at the position of the above-described lubricant application member 67 (refer to FIG. 2) instead of the lubricant application member 67.

In the exemplary embodiments described above, as an example of the fixing device according to an exemplary embodiment of the present invention, a description has been made of the fixing device 60 provided with the lubricant application member 67 as a lubricant supply component separately from the low-friction sheet 68 which is an example of the lubricant dispersion member. However, the fixing device is not limited thereto, and may have a structure that does not include a lubricant supply component other than the lubricant dispersion member.

In the exemplary embodiments described above, as an example of the circularly moving member, the outer peripheral surface of which circularly moves, according to an exemplary embodiment of the present invention, the fixing roll 61 has been described. However, the circularly moving member is not limited thereto, and may be an endless belt, for example.

In the exemplary embodiments described above, as an example of the circularly moving member according to an exemplary embodiment of the present invention, the fixing roll 61 including a heater inside thereof has been described, and as an example of the belt-shaped member according to an exemplary embodiment of the present invention, the endless belt 62 has been described. However, the circularly moving member and the belt-shaped member are not limited thereto. The belt-shaped member may be, for example, a fixing belt including a heater inside thereof.

In the exemplary embodiments described above, as an example of the image forming apparatus according to an exemplary embodiment of the present invention, a tandem-type color printer has been described. However, the image forming apparatus is not limited thereto. The image forming apparatus may be, for example, a monochrome-dedicated printer that does not include an intermediate transfer belt.

In the exemplary embodiments described above, as an example of the image forming apparatus according to an exemplary embodiment of the present invention, a printer has been described. However, the image forming apparatus is not limited to a printer. The image forming apparatus may be, for example, a copy machine or a facsimile configured to form an image on the basis of data read by an image reading apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a circularly moving member, the outer peripheral surface of which circularly moves;
a belt-shaped member that has a substantially belt shape and that circularly moves while an outer peripheral surface of the belt-shaped member is in contact with the outer peripheral surface of the circularly moving member;
a pressing member that presses the belt-shaped member onto the circularly moving member while being in contact with an inner peripheral surface of the belt-shaped member; and
a lubricant dispersion member that includes a solid material and a lubricant dispersed in the solid material in the form of particles,
wherein the lubricant dispersion member is worn by being rubbed on the inner peripheral surface of the belt-shaped member, and the lubricant is exposed on a surface of the solid material by wear, the surface contacting the inner peripheral surface of the belt-shaped member.

2. The fixing device according to claim 1, wherein the lubricant dispersion member constitutes at least a part of the pressing member and is arranged at a position facing the circularly moving member with the belt-shaped member therebetween.

3. The fixing device according to claim 1, wherein the lubricant has a kinematic viscosity of about 50 cSt or more and about 300 cSt or less.

4. The fixing device according to claim 1, wherein the lubricant dispersion member includes a wear layer including the solid material and the lubricant and having a thickness about double the particle diameter of the lubricant or more, the lubricant being exposed by wear to the surface contacting the inner peripheral surface of the belt-shaped member.

5. The fixing device according to claim 1, wherein the lubricant dispersion member includes a wear layer including the solid material and the lubricant, the lubricant being exposed by wear to the surface contacting the inner peripheral surface of the belt-shaped member, and a supporting layer that supports the wear layer.

6. The fixing device according to claim 1, wherein the circularly moving member includes a heating member inside thereof.

7. The fixing device according to claim 1, wherein each of the particles is a microcapsule particle.

8. The fixing device according to claim 1, wherein the solid material is a heat-resistant resin.

9. The fixing device according to claim 8, wherein the heat-resistant resin is selected from a polyimide resin, a polyimide resin, and a polyamide-imide resin.

10. The fixing device according to claim 1, wherein the lubricant is selected from silicone oil, fluorine oil, and synthetic lubricating oil grease prepared by mixing a solid substance and a liquid.

11. The fixing device according to claim 1, wherein the lubricant dispersion member includes about 1 part by weight or more and about 50 parts by weight or less of the lubricant relative to 100 parts by weight of the solid material.

12. An image forming apparatus comprising:
a circularly moving member, the outer peripheral surface of which circularly moves;
a belt-shaped member that has a substantially belt shape and that circularly moves while an outer peripheral surface of the belt-shaped member is in contact with the outer peripheral surface of the circularly moving member;
a pressing member that presses the belt-shaped member onto the circularly moving member while being in contact with an inner peripheral surface of the belt-shaped member; and
a lubricant dispersion member that includes a solid material and a lubricant dispersed in the solid material in the form of particles,
wherein the lubricant dispersion member is worn by being rubbed on the inner peripheral surface of the belt-shaped member, and the lubricant is exposed on a surface of the solid material by wear, the surface contacting the inner peripheral surface of the belt-shaped member.

13. The image forming apparatus according to claim 12, wherein the lubricant dispersion member constitutes at least a part of the pressing member and is arranged at a position facing the circularly moving member with the belt-shaped member therebetween.

14. The image forming apparatus according to claim 12, wherein the lubricant has a kinematic viscosity of about 50 cSt or more and about 300 cSt or less.

15. The image forming apparatus according to claim 12, wherein the lubricant dispersion member includes a wear layer including the solid material and the lubricant and having a thickness about double the particle diameter of the lubricant or more, the lubricant being exposed by wear to the surface contacting the inner peripheral surface of the belt-shaped member.

16. The image forming apparatus according to claim 12, wherein the lubricant dispersion member includes a wear layer including the solid material and the lubricant, the lubricant being exposed by wear to the surface contacting the inner peripheral surface of the belt-shaped member, and a supporting layer that supports the wear layer.
